(19) United States
(12) Patent Application Publication
(10) Pub. No.: US 2006/0027262 A1
(43) Pub. Date: Feb. 9, 2006

(54) Dual stop valve assembly for use in cargo tank vehicles

(76) Inventor: John L. Rademacher, Fond du Lac, WI (US)

Correspondence Address: WHYTE HIRSCHBOECK DUDEK S C, 555 EAST WELLS STREET, SUITE 1900, MILWAUKEE, WI, 53202, US

(21) Appl. No.: 11/215,314

(22) Filed: Aug. 30, 2005

Related U.S. Application Data
(63) Continuation-in-part of application No. 10/864,169, filed on Jun. 9, 2004.
(60) Provisional application No. 60/477,174, filed on Jun. 9, 2003.
(60) Provisional application No. 60/486,954, filed on Jul. 14, 2003.

(51) Int. Cl. F16K 17/36

(52) U.S. Cl. 137/68.14

(57) ABSTRACT

Disclosed is a dual stop valve assembly for use in a cargo tank motor vehicle having a flammable material stowing cargo tank with an external pipe for dispensing the flammable material (e.g., chemicals). The assembly includes an a dual stop valve assembly for use in a cargo tank motor vehicle having a flammable material stowing cargo tank with an external pipe for dispensing the flammable material. The assembly includes an external pipe connection section for connecting the external pipe to the cargo tank; a first stop valve positioned within the external pipe connection section; a second stop valves spaced apart from the first stop valve and positioned within the external pipe connection section; and an actuator for moving the pair of stop valves between a material transport position and a flammable material loading and unloading position. The external pipe connection section includes a break area for promoting breakage of the external pipe connection section along the break area such that, upon breakage along the break area, only an amount of flammable material that is stowed within the external pipe connection section and between the pair of stop valves is discharged. Advantageously, the present invention provides for improved safety in the transport of flammable liquids by providing an apparatus and method for reducing the amount of flammable liquids released in the event of a breakaway event. Moreover, the assembly can be made such that it does not includes any external linkages for effecting movement of the valves.

### CROSS-REFERENCE TO RELATED APPLICATIONS

This application is a continuation-in-part of U.S. Ser. No. 10/864,169, filed Jun. 9, 2004, pending, which also claims the benefit of the filing dates of U.S. application Ser. Nos. 60/477,174 and 60/486,954, filed on Jun. 9, 2003 and Jul. 14, 2003, respectively.

### FIELD AND BACKGROUND OF THE INVENTION

The invention relates generally to petroleum product transportation safety devices, and more particularly to a valve assembly for cargo tank motor vehicles having wet lines.

Cargo tank motor vehicles, specifically models MC 306 and DOT 406, are frequently used in the over-the-road transportation and conveyance of gasoline, fuel oil and other petroleum products. Since Sep. 1, 1995, cargo tank motor vehicles have been required to meet DOT 406 specifications. These types of cargo tanks are low pressure (less than 5 psi) with a cargo capacity generally between 9,000 and 10,000 gallons. With such a large cargo of flammable materials, cargo tank integrity is of high concern, and improvements that enhance the safe transportation of such flammable products are of interest in the industry and to the general public.

Cargo tanks are normally filled by pumping product through external piping. The external piping can carry 30-50 gallons of gasoline or other flammable products from the time of initial loading, through transport, until a first delivery stop. During transport, then, the external pipes are filled with product or are wet, with this condition being known in the industry as having “wet lines”.

However, it has been found that the present systems and processes preclude the evacuation of gasoline in the external lines following loading of the product. Presently, the external lines are drained only after the individual cargo compartments have been unloaded of product during delivery, and then only by gravity. The net result is that the external lines of undelivered cargo compartments remain full of product during transportation.

Generally, cargo tank integrity is protected from collisions that include the external piping through the use of shear sections (sacrificial device) on the external piping that fail first in the event of an accident, and by internal valves to stop the flow of product.

The wet lines condition that exists presently on the cargo tank motor vehicles can make the vehicles vulnerable in side impact collisions involving the external piping of the cargo tank motor vehicles. Clearances (generally 2′ to 4′) between the cargo tank vehicles and the roadway also provide spacing for automobiles to underride the cargo tank in a side collision, resulting in potential damage to the external piping.

In recent years, this condition has been of concern to the National Transportation Safety Board and the Research and Special Programs Administration of the United States Department of Transportation, culminating in proposed rulemaking to reduce safety risks associated with the transportation of flammable liquids in unprotected product piping. Therefore, there is a great recognition in the industry to solve the wet lines problem presently in existence.

The need currently exists to be able to reduce the risk posed by wet lines. Additionally, it has been found that there is a lack of a solution acceptable to all affected parties to the wet lines problem that involves isolation of the flammable liquids contained within the outlet piping assemblies on cargo tank motor vehicles, and within the cargo tank.

Another need that has been identified in the solving of the above problems is the safe and economical retrofitting of existing trailers in service with any new designs. To that end, it would be beneficial if proposed design solutions were dimensionally similar to stop valves currently in service on cargo tankers.

Therefore, an invention solving the aforementioned problems would be highly desirable.

### BRIEF SUMMARY OF THE INVENTION

Disclosed herein is a dual stop valve assembly for use in a cargo tank motor vehicle having a flammable material stowing cargo tank with an external pipe for dispensing the flammable material. The assembly comprises an external pipe connection section for connecting the external pipe to the cargo tank; a pair of stop valves spaced apart and operable within the external pipe connection section; and an actuator for actuating opening of each of the pair of stop valves between a material transport position and a flammable material loading/unloading position. The external pipe connection section includes a break area for promoting breakage of the external pipe connection section along the break area such that, upon breakage along the break area, only an amount of flammable material that is stowed within the external pipe connection section and between the pair of stop valves is discharged.

Other objects, aspects, and advantages of the invention will be apparent upon a thorough reading of the detailed description below along with the drawings.

### BRIEF DESCRIPTION OF THE DRAWINGS

Embodiments of the invention are disclosed with reference to the accompanying drawings and are for illustrative purposes only. The invention is not limited in its application to the details of construction or the arrangement of the components illustrated in the drawings. The invention is capable of other embodiments or of being practiced or carried out in other various ways. Like reference numerals are used to indicate like components. In the drawings:

FIG. 1 is a schematic side view of a cargo tank motor vehicle having a cargo tank incorporating the present invention;

FIG. 2 is an enlarged view of one embodiment of an inventive dual stop valve assembly shown in an open position and taken along line 2-2 of FIG. 1;

FIG. 3 is a cross-sectional view of one embodiment of the dual stop valve assembly shown in an open position;

FIG. 4 is a cross-sectional view of one embodiment of the dual stop valve assembly shown in a closed position;

FIG. 5 is an enlarged view similar to FIG. 2 with the inventive dual stop valve assembly shown in a closed position;

FIG. 6 is an enlarged portion of one embodiment of the dual stop valve assembly taken along line 6-6 of FIG. 4 showing a shear section;

FIG. 7 is an enlarged view similar to FIG. 5 illustrating the inventive dual stop valve assembly during breakaway;

FIG. 8 is a cross-sectional cutaway view of the dual stop valve assembly showing the upper valve assembly portion 64a post breakaway;

FIG. 9 is a schematic cross-sectional view taken along line 9-9 of FIG. 8;

FIG. 10 is a cross-sectional view of another embodiment of the dual stop valve assembly;

FIG. 11 is an enlarged portion of an embodiment of the dual stop valve assembly taken along line 11-11 of FIG. 10;

FIG. 12 is a cross-sectional view of another embodiment of the dual stop valve assembly in accordance with the present invention;

FIG. 13 is an enlarged portion of an embodiment of the dual stop valve assembly taken along line 13-13 of FIG. 12;

FIG. 14 is a cross-sectional view of another embodiment of the dual stop valve assembly in accordance with the present invention;

FIG. 15 is a cross-sectional view of another embodiment of the dual stop valve assembly in accordance with the present invention; and

FIG. 16 is a cross-sectional view of another embodiment of the dual stop valve assembly in accordance with the present invention.

### DETAILED DESCRIPTION OF THE PREFERRED EMBODIMENTS

FIG. 1 is a schematic side view of a cargo tank motor vehicle 10 having a cab 12 and a cargo tank trailer 14 connectable thereto. Trailer 14 includes a cargo tank 16 for holding and transporting a material. In the embodiment shown, the tank includes several compartments or sections 18a-d, and thus, the tank is capable of transporting a plurality of materials. The materials for which the invention is designed include petroleum products (e.g., gasoline, fuel oil, kerosene) or other hazardous or flammable products. Exemplary cargo tank motor vehicles contemplated for use with the present invention include MC306 and DOT406 vehicles. Such vehicles can be constructed from mild or stainless steel, or aluminum (e.g., desirable due to it low weight) and typically have a cargo capacity of between 9000 and 10000 gallons. Each cargo tank section 18a-d is connected to an external pipe 20a-d through which the contents of the individual section are pumped in or drawn out. Each external pipe 20a-d terminates in a spigot or valve 22 to dispense the respective material held in the respective tank section. Connecting each external pipe 20a-d to each cargo section 18a-d are inventive valve assemblies 24, 26, 28 and 30. The valve assemblies, as can be seen, are positioned below the cargo sections and thus are vulnerable to impact (and particularly side impacts) from, for example, another motor vehicle. Such impacts result in wet lines and the associated discharge of hazardous material from the piping. It is a significant aspect of the present invention that the present inventive valve assemblies, whether newly installed or part of a retrofit assembly, will serve to isolate and protect wet lines in cargo tankers and thus minimize discharge of hazardous products.

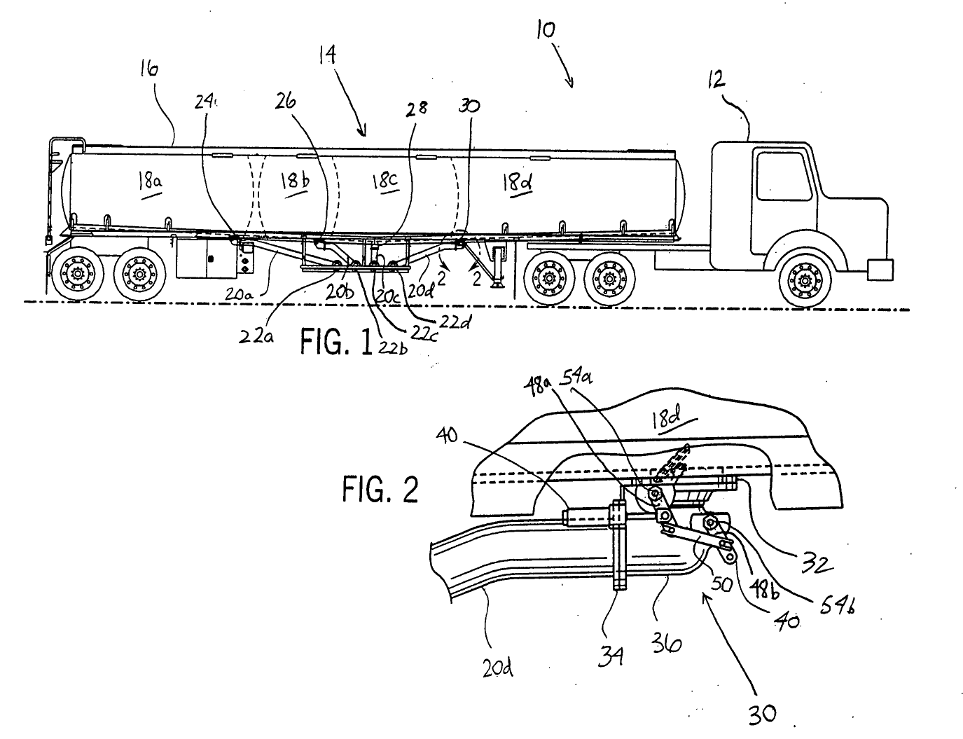

FIG. 2 is an enlarged view of one embodiment of an inventive dual stop valve assembly 30 (also called a dual closing stop valve assembly) shown in an open position and taken along line 2-2 of FIG. 1. The dual stop valve assembly is connected to the cargo tanker (FIG. 1) and to an external pipe 20d. The assembly 30 is situated between the external pipe 20d and cargo tank section 18d and is connected thereto via a flange section 32. The assembly is connected to the pipe 20d via connecter 34.

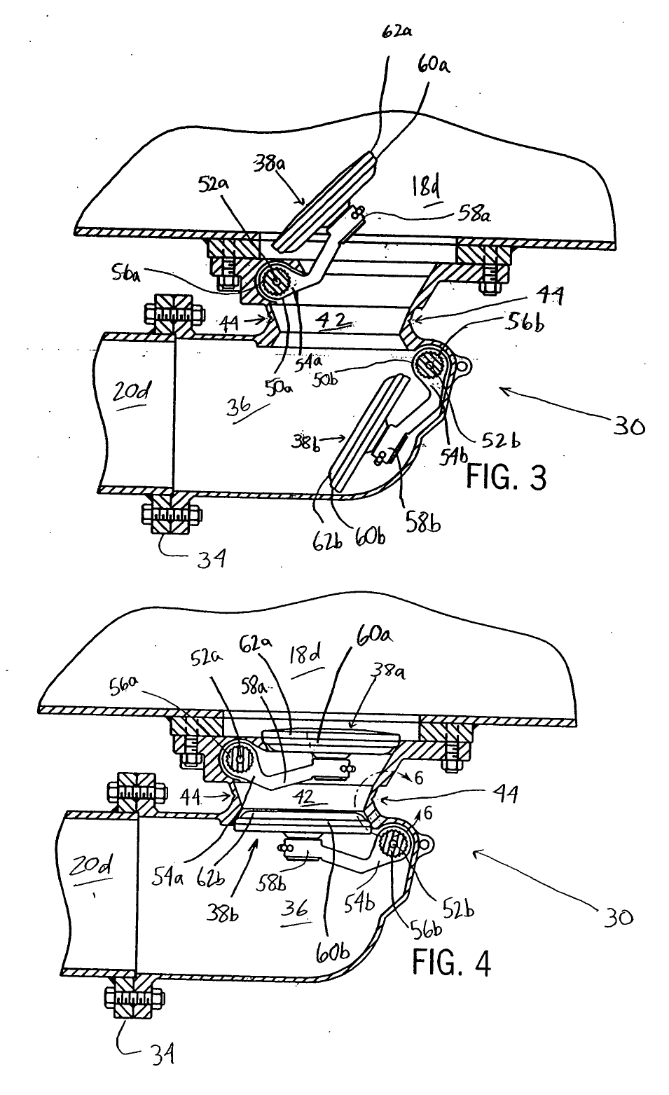

FIG. 3 is a cross-sectional view of one embodiment of the dual stop valve assembly 30 shown in an open position and FIG. 4 is a cross-sectional view of one embodiment of the dual stop valve shown in a closed position. The dual stop valve assembly 30 includes an external pipe connection section 36 for connecting the external pipe (via connector 34) to the cargo tank 18, and more specifically cargo tank section 18d. The assembly 30 further includes a pair of stop valves 38a-b spaced and operable within the external pipe connection section 36. One of the pair of stop valves 38a is for sealing and containing a flammable material within the cargo tank section 18d and the other of the pair of stop valves 38b is for sealing and containing the flammable material within, primarily within, the external pipe 36. An actuator 40 (see FIG. 2) is used for actuating opening of each of the pair stop valves 38a-b between a material transport position (FIG. 4) in which the valves are closed and a flammable material loading/unloading position (FIG. 3) in which the valves are open. Both valves are self-closing by means of spring action. The external pipe connection section 36 includes a break area 42 (also called a “shear section”) for promoting sacrificial breakage of the external pipe connection section along the break area such that, upon breakage along the break area, only an amount of flammable material that is stowed within the external pipe connection section and between the pair of stop valves is discharged.

Referring to FIGS. 2-4, in this embodiment, actuator 40 is secured in a known fashion to the external pipe connection section 36, and is further mechanically connected to impart motion to valves 38a-b via linkage arms 48a-b. Linkage arm 50 is connected to linkage 48a-b so as to synchronize motion of the arms, and ultimately, the valves between open and closed positions, as illustrated in FIGS. 3 and 4 respectively. The actuator can take various forms, such as mechanical, hydraulic or pneumatic. The actuator can also be referred to as actuating means.

In the embodiment illustrated, valves 38a-b are rotatable about their respective pivot point 52a-b located at the center of spindles 56a-b such that the valves rotate in same directions (i.e., as shown, valves 38a-b rotate in counterclockwise fashion when the valves are opened during loading/unloading of material into or out of the cargo tank as shown in FIG. 3 and valves 38a-b rotate in clockwise fashion to achieve a closed position suitable during material transport as shown in FIG. 4). Stated another way, the spindles are located on opposite sides of the external pipe section such that, when the poppets are opened and closed, the spindles rotate in the same direction. Self-closing spring return assemblies 54a-b are used to facilitate, in conjunction with the actuator, opening and closing of the valves 38a-b as they rotate about spindles 56a-b. Stop valves 38a-b further include lift forks 58a-b, to which O-ring or other seals or sealing means 60a-b and poppets 62a-b are connected in a known fashion. Advantageously, each of the plurality of linkage arms is individually removable for leakage testing of each of the pair of valves individually to ensure valve-seal integrity.

FIG. 6 is an enlarged portion of one embodiment of the dual, stop valve taken along line 6-6 of FIG. 4, specifically showing shear section 42. As illustrated, the shear section includes a notch-shaped groove 44 that runs substantially about an outer perimeter of a wall 46 of the shear section 42. It is contemplated that the shear section can take on other shapes or forms, however, the shear section is generally defined or characterized by an area of reduced material or reduced material thickness. Such reduction results in a line or area of weakness that when, by way of example, an impact or force is applied to a generalized region encompassing the material reduction area, breakage is promoted (i.e., likely to occur) along the area. Such breakaway (also called a “breakaway event”) will occur, by definition, at a force that is below a force necessary to break adjoining non-shear section areas of the external pipe connection section 36.

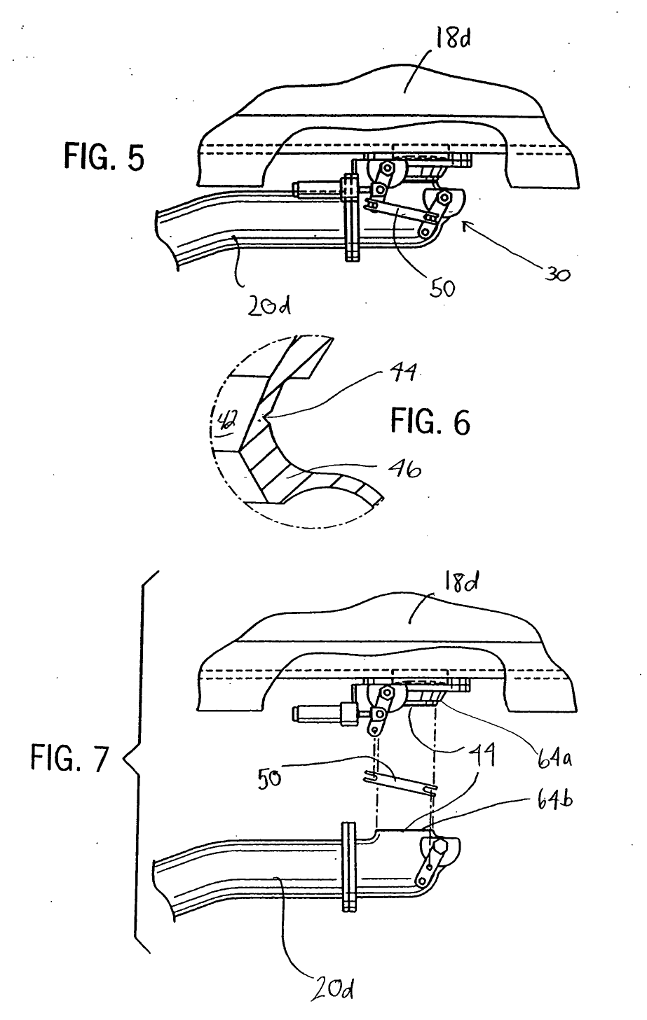

FIG. 5 is an enlarged view similar to FIG. 2 with the inventive dual stop valve assembly 30 shown in the material transport or closed position. As noted above, FIG. 6 is an enlarged portion of one embodiment of the dual stop valve assembly showing the shear section. And FIG. 7 is an enlarged view similar to FIG. 5 illustrating the inventive dual stop valve assembly during breakaway. During an impact that causes breakaway (i.e., a breakaway impact), dual stop valve assembly 30 breaks along shear section 44 into a first or upper dual stop valve assembly portion 64a and a second or lower dual stop valve assembly portion 64b. More specifically, as shown, linkage 50 may become dislodged to permit the lower portion 64b to fall away and, in conjunction with the closing of the stop valves (and in particular valve 38b), contain material with the external pipe 20d. In addition, upper 64a remains connected to the cargo tanker section 18d. As a result, even if an impact causes dual stop valve assembly to be dislodged from its associated cargo tank section and translated to a resting position, the flammable contents will be effectively isolated from potential ignition sources. That is, only a nominal volume of flammable liquids (i.e., the contents encapsulated between the poppets of the stop valve) would possibly be released. Stated another way, only a small quantity (i.e., about a cup or less) of material (i.e., material located in the area between the stop valves) is dispensed or released.

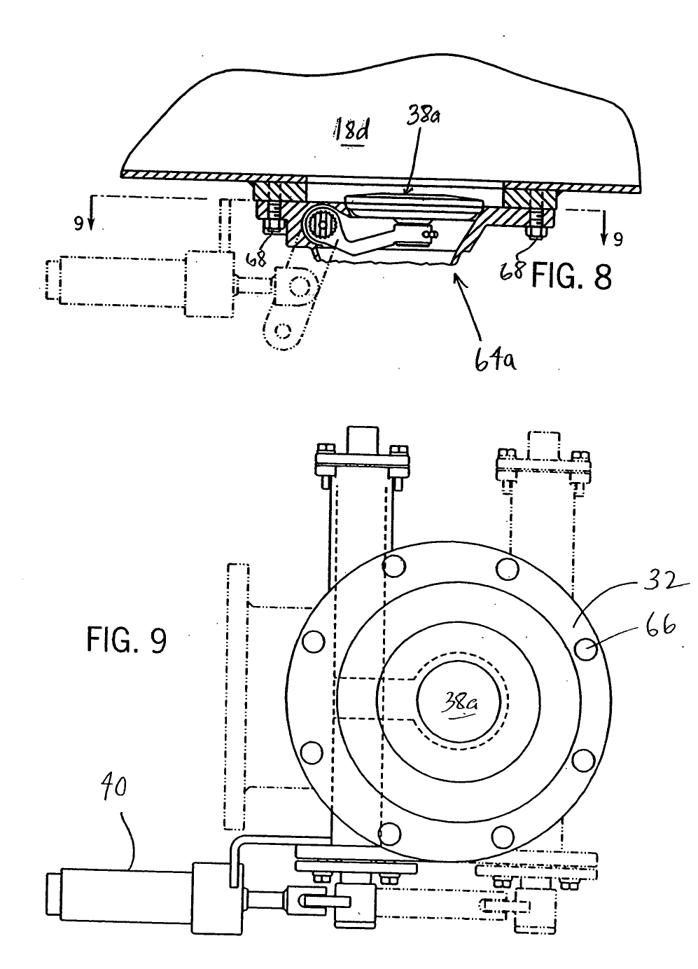

FIG. 8 is a cross-sectional cutaway view of the dual stop valve assembly showing the upper valve assembly portion 64a post breakaway. FIG. 9 is a schematic cross-sectional view taken along line 9-9 of FIG. 8. As shown, valve 38a is in a closed position so as to seal flammable material within cargo section 18d. Shown in phantom is actuator 40, which again, accomplishes the opening of the valve. Valve assembly again includes flange section 32 having holes 66 for permitting connection of the assembly to the cargo tank section 18d, as by bolts or other connection means 68.

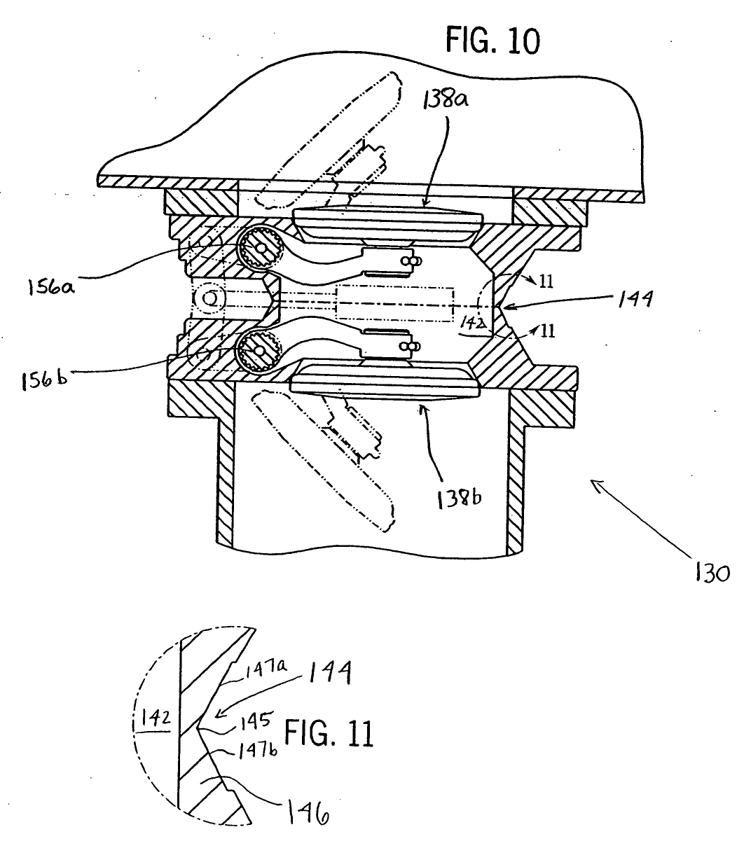

FIG. 10 is a cross-sectional view of another embodiment of the dual stop valve 130 and FIG. 11 is an enlarged portion of an embodiment of the dual stop valve taken along line 11-11 of FIG. 10. This embodiment still includes two stop valves 138a-b, however in this instance, the valves are situated so that valve 138a is located over valve 138b. In this embodiment, the valves rotate about their respective spindles 156a-b such that they now rotate in opposite directions when moving from their closed position shown, or open position (shown in phantom). Stated another way, the spindles are located on opposite sides of the external pipe section such that, when the poppets are opened and closed, the spindles rotate in opposite directions. As illustrated, the shear section includes a vertex 145 and two flat section 147a-b to create a groove 144 that runs substantially about an outer perimeter of a wall 146 of the shear section 142. The groove again constitutes an area of reduced material or reduced material thickness to promote breakaway.

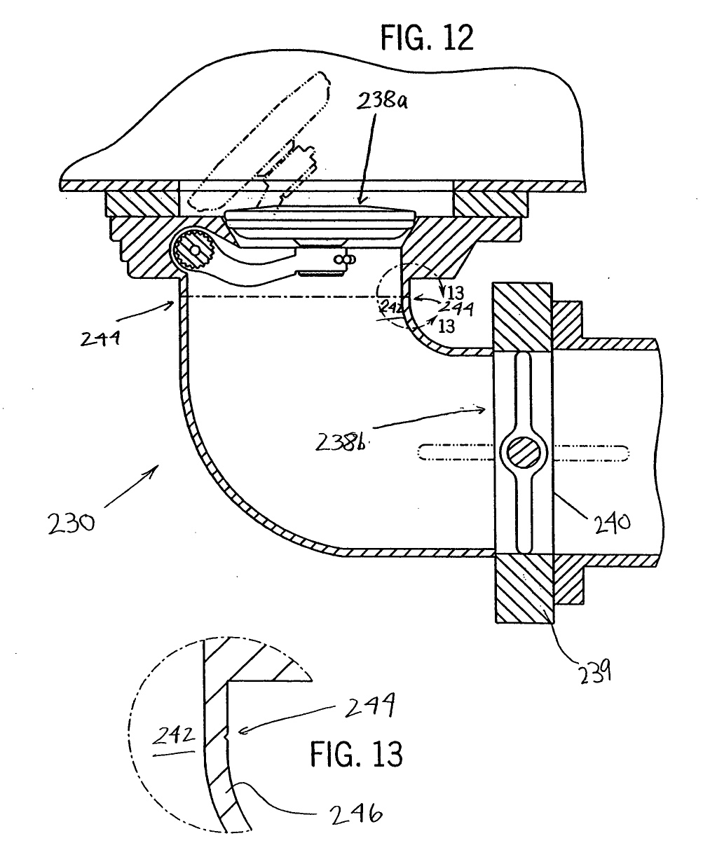

FIG. 12 is a cross-sectional view of another embodiment of the dual stop valve 230 in accordance with the present invention and FIG. 13 is an enlarged portion of an embodiment of the dual stop valve taken along line 13-13 of FIG. 12. In this embodiment, the valve assembly 230 includes a first valve 238a comprising a poppet and a second valve 238b of the butterfly variety, which is situated within a disc 239 to form a disc assembly 240. The principal of operation is similar to that described above in that both valves move simultaneously (or substantially simultaneously) from their closed position during transport and their open position during loading/unloading (shown in phantom), with a shear section 242 disposed between the valves. As illustrated, the shear section includes a notched groove 244 that runs substantially about an outer perimeter of a wall 246 of the shear section 242. The groove again constitutes an area of reduced material or reduced material thickness to promote breakaway.

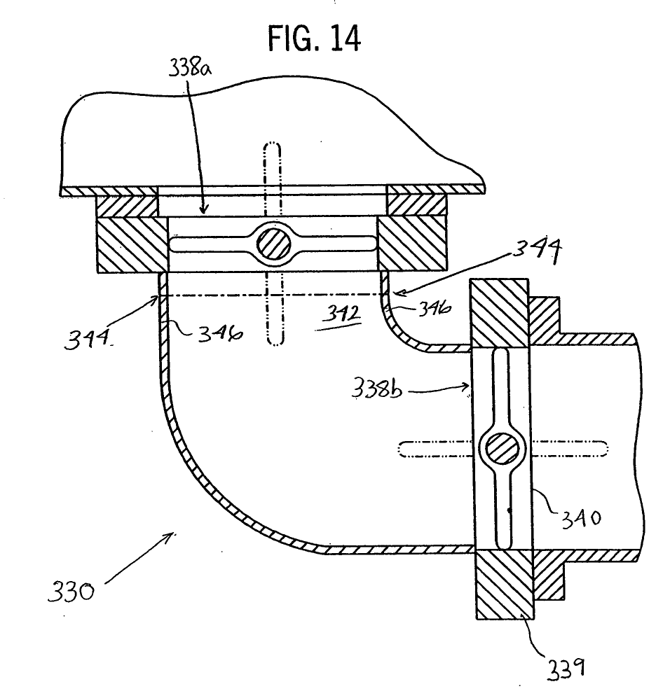

FIG. 14 is a cross-sectional view of another embodiment of the dual stop valve 330 in accordance with the present invention. The embodiment is the “dual butterfly valve assembly” embodiment. In this embodiment, the valve assembly 330 includes a first valve 338a and a second valve 238b, both of the butterfly variety, again positioned within a disc 339 to form a disc assembly 340. The principal of operation is similar to that described above in that both valves move simultaneously (or substantially simultaneously) from their closed position during transport and their open position during loading/unloading (shown in phantom), with a shear section 342 disposed between the valves. As illustrated, the shear section includes a notched groove 344 that runs substantially about an outer perimeter of a wall 346 of the shear section 342. The groove again constitutes an area of reduced material or reduced material thickness to promote breakaway.

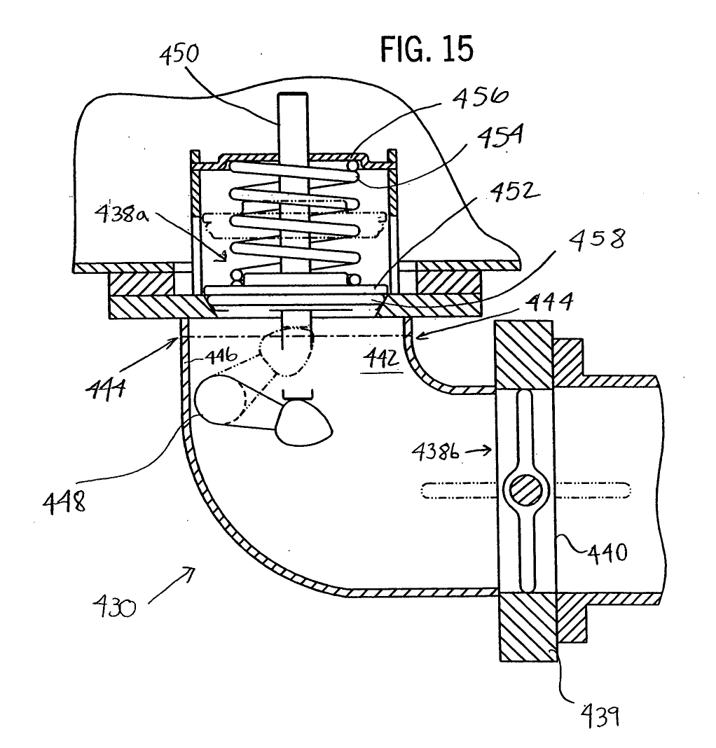

FIG. 15 is a cross-sectional view of another embodiment of the dual closing valve in accordance with the present invention. The embodiment is referred to as the “Cam-butterfly valve assembly”. In this embodiment, the valve assembly 430 includes a first valve 438a and a second valve 438b. Here, the first valve 438a includes a cam 448 that moves cam stem 450 which is connected to disc 452 to move and thereby compress spring 454. The disc 452 compresses spring 454 within cage 456. Here again, valve 438a includes seal 458 of an O-ring type. The generally principal of operation is similar to that described above in that both valves move simultaneously (or substantially simultaneously) from their closed position during transport and their open position during loading/unloading (shown in phantom), with a shear section 442 disposed between the valves. As illustrated, the shear section includes a notched groove 444 that runs substantially about an outer perimeter of a wall 446 of the shear section 442. The groove again constitutes an area of reduced material or reduced material thickness to promote breakaway.

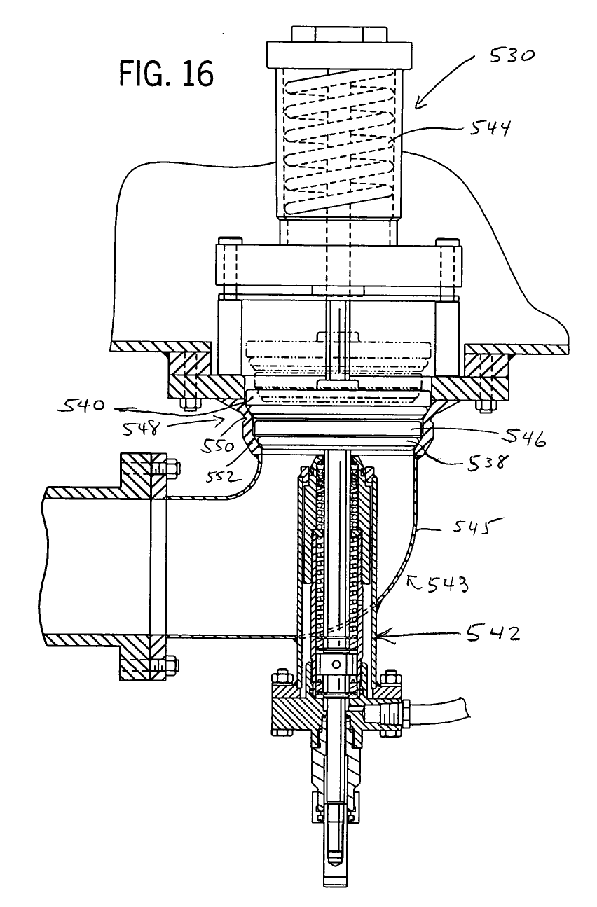

FIG. 16 is a cross-sectional view of another embodiment of the dual stop valve assembly in accordance with the present invention. This embodiment can be referred to as a “Double Poppet Dry Break Valve Assembly”. In this embodiment, valve assembly 530 again includes a first valve 538 and a second valve 540. As shown, the valves are poppet valves. Here, a cylinder 542, or actuator, located within elbow portion 543 of assembly 530, raises the lower valve 538, which in turn contacts the upper valve 540 so as to elevate or drive the upper valve upperwardly. In one embodiment cylinder 542 is a hydraulic valve, and in another embodiment, the cylinder is a pneumatic cylinder. Upper valve 540 is connected to, as shown, a coil spring 544 which compresses as the upper valve moves upwardly. Here again, valve 538 includes seal 546 of an O-ring type. In general, the valves are in a closed position during transport and an open position during loading/unloading. Advantageously, there are no external linkages (i.e., linkages located external of the assembly housing or wall) connecting the valves, for again, the lower valve raises the upper valve. A break or shear section 548 is again disposed between the valves. As illustrated, the shear section includes a notched groove 550 that runs substantially about an outer perimeter of a wall 552 of the shear section 548. The groove again constitutes an area of reduced material or reduced material thickness to promote breakaway. Advantageously, this “dry break design” results in very small amounts of material between the valves and a reduced amount of potential contamination during assembly breakage upon impact (and along the shear section). As a result, suitable applications or environments for the assembly 530 include chemical trailers.

Also disclosed is a method of operating a dual stop valve assembly in a trailer having a flammable material stowing cargo tank and an external pipe for transporting a flammable material from the tank. The method comprises: attaching a dual stop valve assembly to a vehicle, the assembly including a pair of stop valves spaced and operable within an external pipe connection section, one of the pair of stop valves for sealing a flammable material within the cargo tank and the other of the pair of stop valves for sealing the flammable material within the external pipe. The method further comprises closing the first valve to isolate fluid communication within the tank and closing a second valve to isolate fluid communication within the outlet pipe. The external pipe connection section includes a break area for promoting breakage of the external pipe connection section along the break area such that, following the closing steps, and upon breakage along the break area, only an amount of flammable material that is stowed within the external pipe connection section and between the pair of stop valves is discharged. In at least one embodiment, the closing steps occur substantially simultaneously. In one embodiment, at least 2 actuators could be used.

Despite any methods being outlined in a step-by-step sequence, the completion of acts or steps in a particular chronological order is not mandatory. Further, modification, rearrangement, combination, reordering, or the like, of acts or steps is contemplated and considered within the scope of the description and claims.

While the present invention has been described in terms of a preferred embodiment(s), it is recognized that equivalents, alternatives, and modifications, aside from those expressly stated, are possible and within the scope of the appending claims.

What is claimed is:

1. A dual stop valve assembly for use in a cargo tank motor vehicle having a flammable material stowing cargo tank with an external pipe for dispensing the flammable material, the assembly comprising:
an external pipe connection section for connecting the external pipe to the cargo tank;
a first stop valve positioned within the external pipe connection section;
a second stop valve spaced apart from the first stop valve and positioned within the external pipe connection section; and
an actuator for moving the pair of stop valves between a material transport position and a flammable material loading and unloading position;
wherein the external pipe connection section includes a break area for promoting breakage of the external pipe connection section along the break area such that, upon breakage along the break area, only an amount of flammable material that is stowed within the external pipe connection section and between the pair of stop valves is discharged.

2. The dual stop valve assembly of claim 1 wherein the actuator is secured to the external pipe connection section and is mechanically connected to at least the first valve, with the first valve contacting the second valve to move the second valve.

3. The dual stop valve assembly of claim 1 wherein the first and second valves are poppet valves.

4. The dual stop valve assembly of claim 1 wherein the actuator is one of hydraulic and pneumatic.

5. The dual stop valve assembly of claim 1 wherein, during a breakaway impact, the dual stop valve assembly breaks along the shear section into an upper dual stop valve assembly portion and a lower dual stop valve assembly portion.

6. The dual stop valve assembly of claim 1 wherein the stop valves are rotatable such that the valves rotate to one of an open position during loading/unloading of material into or out of the cargo tank and a closed position during material transport.

7. The dual stop valve assembly of claim 1 further comprising shear section.

8. The dual stop valve assembly of claim 7 wherein the shear section includes a notch-shaped groove that runs substantially about an outer perimeter of a wall of the shear section.

9. The dual stop valve assembly of claim 8 wherein the shear section includes an area of reduced material thickness.

10. The dual stop valve assembly of claim 1 wherein the actuator is positioned within an elbow portion of the assembly.

11. The dual stop valve assembly of claim 1 wherein the second valve is connected to a spring that compresses as the second valve moves upwardly.

12. The dual stop valve assembly of claim 1 wherein the assembly does not comprise any external linkages for effecting movement of the stop valves.
